(19) United States
(12) Patent Application Publication
(10) Pub. No.: US 2024/0427043 A1
(43) Pub. Date: Dec. 26, 2024

(54) GEOLOGICAL STRUCTURE CHARACTERIZATION METHOD BASED ON SEISMIC VELOCITY SIGNAL AND ACCELERATION SIGNAL

(71) Applicant: Chengdu University of Technology, Chengdu (CN)

(72) Inventors: Yuyong YANG, Chengdu (CN); Li YOU, Chengdu (CN); Chuan LUO, Chengdu (CN); Zhengyang WANG, Chengdu (CN); Huailai ZHOU, Chengdu (CN)

(21) Appl. No.: 18/762,513

(22) Filed: Jul. 2, 2024

(30) Foreign Application Priority Data
Jul. 4, 2023 (CN) 202310807076.4

(51) Int. Cl. G01V 1/30

(52) U.S. Cl. CPC G01V 1/303; G01V 2210/64

(57) ABSTRACT

A geological structure characterization method based on a seismic velocity signal and a seismic acceleration signal is provided. The seismic acceleration signal and the seismic velocity signal are acquired and normalized. Constant-phase wavelet and minimum-phase wavelet extraction or mixed-phase wavelet extraction is performed. In the constant-phase wavelet and minimum-phase wavelet extraction, a first minimum-phase wavelet is extracted based on the seismic velocity signal, and a constant-phase wavelet is extracted based on the seismic acceleration signal, and converted to a second minimum-phase wavelet. A residual between the first minimum-phase wavelet and the second minimum-phase wavelet is calculated. If the residual is greater than a preset threshold, the constant-phase wavelet extraction is performed again, otherwise, the first minimum-phase wavelet and the constant-phase wavelet are output.

### CROSS-REFERENCE TO RELATED APPLICATIONS

This application claims the benefit of priority from Chinese Patent Application No. 202310807076.4, filed on Jul. 4, 2023. The content of the aforementioned application, including any intervening amendments thereto, is incorporated herein by reference in its entirety.

### TECHNICAL FIELD

This application relates to petroleum geophysical exploration, and more specifically to a geological structure characterization method based on a seismic velocity signal and a seismic acceleration signal, which involves wavelet extraction of the seismic velocity signal and the seismic acceleration signal and deconvolution.

### BACKGROUND

Petroleum and natural gas are important strategic energy resources, but in recent years, the increasing dependence on petroleum import has greatly aggravated the supply and security problems of petroleum and natural gas. In view of this, extensive attempts have been made to enhance the exploration and production of petroleum and natural gas. Reflective seismic exploration is proposed to obtain the structure and lithology of strata by using reflected wave data, while the recognition accuracy of the structure and lithology of strata is seriously restricted by the unsatisfied characterization accuracy of geological structure.

At present, the deconvolution of the extracted seismic wavelets is commonly used in the fine characterization of geological structure. In a conventional method, only one type of signal (velocity signal or acceleration signal) is acquired and processed to characterize the underground structure. Obviously, this method cannot effectively take characteristics of the two signals into account, and is dependent on the phase correction factor during the wavelet extraction. Therefore, it is urgent to develop a wavelet extraction method with improved accuracy to improve the characterization accuracy of subsurface structures.

### SUMMARY

An objective of the present disclosure is to provide a geological structure characterization method based on a seismic velocity signal and an acceleration signal to overcome the above technical problems.

Technical solutions of the present disclosure are described below.

A geological structure characterization method based on a seismic velocity signal and a seismic acceleration signal, comprising:
acquiring the seismic acceleration signal and the seismic velocity signal;
normalizing the seismic acceleration signal and the seismic velocity signal; and
based on wavelet phase requirements, setting parameters to carry out constant-phase wavelet and minimum-phase wavelet extraction or to extract a mixed-phase wavelet.

In some embodiments, the constant-phase wavelet and minimum-phase wavelet extraction is performed through the following steps:
(S1) extracting a first minimum-phase wavelet based on a normalized seismic velocity signal;
(S2) extracting a constant-phase wavelet based on a normalized seismic acceleration signal; and converting the constant-phase wavelet to obtain a second minimum-phase wavelet; and
(S3) calculating a residual between the first minimum-phase wavelet and the second minimum-phase wavelet;
if the residual is greater than a preset threshold, returning to step (S2) and performing constant-phase wavelet extraction again;
if the residual is less than or equal to the preset threshold, outputting the first minimum-phase wavelet and the constant-phase wavelet.

In some embodiments, in step (S1), the first minimum-phase wavelet is extracted based on the normalized seismic velocity signal through the following formulas:

$$a ( n ) = u ( n ) {a}_{o} ( n ) ;$$

$$u ( n ) = \{ \begin{matrix}0 & n < 0 \\ 1 & n = 0 \\ 2 & n > 0\end{matrix} ;$$

$${a}_{o} ( n ) = IFFT ( {A}_{o} ( ω ) ) ; and$$

$${A}_{o} ( ω ) = ln \vert X ( ω ) \vert ;$$

wherein a(n) represents the first minimum-phase wavelet; u(n) represents a coefficient; aₒ(n) is an odd-part sequence of a(n); n represents a time sequence; IFFT represents Fourier inverse transform; Aₒ(ω) represents a Fourier transform result of aₒ(n); and |X(ω)| represents an amplitude spectrum of a seismic record.

In some embodiments, in step (S2), the constant-phase wavelet is extracted based on the normalized seismic acceleration signal through the following formulas:

$$g ( a , n ) = b ( n ) cos ( a ) - {h}_{b} ( n ) sin ( a ) ; and$$

$$b ( n ) = IFFT ( \vert X ( ω ) \vert ) ;$$

wherein g(a, n) represents the constant-phase wavelet; b(n) represents a zero-phase wavelet; a represents a phase correction factor; h_{b}(n) is a Hilbert transform result of b(n); IFFT represents Fourier inverse transform; and |X(ω)| represents an amplitude spectrum of a seismic record.

In some embodiments, the phase correction factor is expressed as:

$$a = \frac{π}{k} , k = 1 , 2 , 3 … ;$$

wherein k is a positive integer.

In some embodiments, the mixed-phase wavelet is extracted through the following formula:

$$w = IFFT ( W ) ; and$$

$$W = sin ( {Φ}^{′} ) \vert W \vert + j cos ( {Φ}^{′} ) \vert W \vert ;$$

wherein w represents the mixed-phase wavelet; IFFT represents Fourier inverse transform; W represents a wavelet frequency spectrum; Φ′ represents a wavelet phase spectrum; |W| represents a wavelet amplitude spectrum; and j is an imaginary number.

In some embodiments, the wavelet phase spectrum Φ′ is calculated through the following formulas:

$${Φ}^{′} = {( {A}_{pha}^{T} {A}_{pha} )}^{- 1} {A}_{pha}^{T} {φ}^{′} ;$$

$${A}_{pha} = [ \begin{matrix}2 & - 1 & 0 & 0 & … & 0 & 0 \\ 1 & 1 & - 1 & 0 & … & 0 & 0 \\ ⋮ & ⋮ & ⋮ & ⋮ & ⋱ & ⋮ & ⋮ \\ 1 & 0 & 0 & 0 & … & 1 & - 1 \\ 0 & 2 & 0 & - 1 & … & 0 & 0 \\ ⋮ & ⋮ & ⋮ & ⋮ & ⋱ & ⋮ & ⋮ \\ 0 & 0 & 0 & 0 & ⋱ & 0 & 1\end{matrix} ] ; and$$

$${φ}^{′} = {( {φ}^{′} ( 1 , 1 ) , {φ}^{′} ( 1 , 2 ) , … , \\ {φ}^{′} ( 1 , N - 1 ) , {φ}^{′} ( 2 , 2 ) , … , {φ}^{′} ( 2 , N - 2 ) , … , {φ}^{′} ( \frac{N}{2} , \frac{N}{2} ) )}^{T} ;$$

wherein Aₚₕₐ is a (N²/4)×N matrix; T represents a matrix transpose operation; −1 denotes a matrix inversion operation; q′ is a (N²/4)×1 column vector; and N represents a size of a higher-order cumulant matrix.

In some embodiments, the amplitude spectrum |W| of the mixed-phase wavelet is calculated through the following formulas:

$$\vert W ( n ) \vert = \{ \begin{matrix}{e}^{{W}^{′} ( n )} , n = 1 , 2 , 3 , … , N / 2 \\ \vert W ( N - n ) \vert , n = \frac{N}{2} + 1 , \frac{N}{2} + 2 , … , N - 1\end{matrix} ;$$

$${W}^{′} = {( {A}_{a m p}^{T} {A}_{a m p} )}^{- 1} {A}_{a m p}^{T} {X}^{′} ;$$

$${A}_{amp} = [ \begin{matrix}2 & 1 & 0 & 0 & … & 0 & 0 \\ 1 & 1 & 1 & 0 & … & 0 & 0 \\ ⋮ & ⋮ & ⋮ & ⋮ & ⋱ & ⋮ & ⋮ \\ 1 & 0 & 0 & 0 & … & 1 & 0 \\ 0 & 2 & 0 & 1 & … & 0 & 0 \\ ⋮ & ⋮ & ⋮ & ⋮ & ⋱ & ⋮ & ⋮ \\ 0 & 0 & 0 & 0 & ⋱ & 0 & 1\end{matrix} ] ; and$$

$${X}^{′} = {( {X}^{′} ( 1 , 1 ) , {X}^{′} ( 1 , 2 ) , … , {X}^{′} ( 1 , \frac{N}{2} - 1 ) , \\ {X}^{′} ( 2 , 2 ) , … , {X}^{′} ( 2 , \frac{N}{2} - 2 ) , … , {X}^{′} ( \frac{N}{4} , \frac{N}{4} ) )}^{T} ;$$

wherein |W(n)| represents the wavelet amplitude spectrum; e represents a base of a natural logarithm function; W′(n) represents a natural logarithm of the wavelet amplitude spectrum; n represents a time sequence; N represents a size of a higher-order cumulant matrix; |W(N−n)| represents a part of the wavelet amplitude spectrum greater than one half of a wavelet length; W′ represents a (N/2)×1 column vector, Aₐₘₚ represents a (N²/16)×(N/2) matrix; T represents a matrix transpose operation; −1 represents a matrix inversion operation; and X′ represents a (N²/16)×1 column vector.

The beneficial effects of the present disclosure are described below.

In the present disclosure, wavelets are extracted based on combination of seismic velocity signals and seismic acceleration signal, which can improve the accuracy of wavelet extraction of seismic signals, and solve the problems in the existing technology that the wavelet extraction only involves a single signal, and is excessively dependent on the selected signal and the phase correction factor.

The deconvolution process is performed as follows.

The minimum-phase wavelet a or the constant-phase wavelet g or the mixed-phase wavelet w obtained by the combined wavelet extraction are used to calculate the corresponding inverse wavelets @′, g′ and we′, respectively. The relationship between a wavelet and its corresponding inverse wavelet (taking the mixed-phase wavelet w as an example) is expressed by:

$$w * {w}^{′} = 1 ; \qquad ( 1 )$$

where * represents a convolution symbol.

Therefore, the inverse wavelet w′ of the mixed-phase wavelet can be expressed as:

$${w}^{′} = IFFT ( 2 πδ ( ω ) - FFT ( ω ) ) ; \qquad ( 2 )$$

where δ(ω) represents an impulse function.

The reflection coefficient r can be obtained by convolution of the inverse wavelet w obtained by formula (2) with the seismic record x, expressed as:

$$r = {w}^{′} * x . \qquad ( 3 )$$

The reflection coefficient obtained by formula (3) is subjected to convolution with the high-frequency wavelet to obtain the fine characterization result.

On the fine characterization image, the number of traces and time for recognizing pinch-out points are represented by Trc and Tim, respectively. Assuming that the trace spacing is dx (the distance between two neighboring seismic traces), the transverse position X_j of the recognized pinch-out point is:

$$X\_j = Trc * dx . \qquad ( 4 ) .$$

Assuming that the average velocity from the surface to the pinch-out point stratum is v, the longitudinal position of the recognized pinch-out point D_j is:

$$D\_j = Tim * v . \qquad ( 5 ) .$$

The pinch-out point location (X_j, D_j) after fine characterization can be obtained through formulas (4) and (5).

The present disclosure can improve the resolution of seismic data through fine characterization of geological structure based on joint extraction of seismic velocity signals and seismic acceleration signals, which can realize more fine and accurate identification of geological formations, and solve the problems of excessive dependence on the phase correction factor during the characterization and wavelet extraction using only a single kind of signal in the existing technology.

### BRIEF DESCRIPTION OF THE DRAWINGS

To more clearly illustrate the technical solutions of the embodiments of the present disclosure or technical solutions in the prior art, the accompanying drawings needed in the description of the embodiments or the prior art will be introduced briefly below. Obviously, presented in the accompanying drawings are only some embodiments of the present disclosure, and other accompanying drawings can be obtained by one of ordinary skill in the art based on these drawings without creative labor.

FIG. 1 is a flow chart of a geological structure characterization method based on seismic velocity signals and seismic acceleration signals according to an embodiment of the present disclosure;

FIGS. 2a-2b schematically show seismic signals according to Embodiment 1 of the present disclosure, where (a): velocity signal; and (b) acceleration signal;

FIGS. 3a-3b schematically show a velocity wavelet and an acceleration wavelet extracted in the characterization method according to Embodiment 1 of the present disclosure, where (a): velocity wavelet; and (b): acceleration wavelet;

FIG. 4 schematically show a mixed-phase wavelet extracted in the characterization method according to Embodiment 1 of the present disclosure;

FIGS. 5a-5b schematically show seismic signals according to Embodiment 2 of the present disclosure, where (a): velocity signal; and (b) acceleration signal;

FIGS. 6a-6b schematically show a velocity wavelet and an acceleration wavelet extracted in the characterization method according to Embodiment 2 of the present disclosure, where (a): velocity wavelet; and (b): acceleration wavelet;

FIGS. 7a-7b schematically show a velocity wavelet and an acceleration wavelet respectively extracted by an existing method, where (a): velocity wavelet; and (b): acceleration wavelet;

FIG. 8 schematically shows a mixed-phase wavelet extracted by the characterization method according to Embodiment 2 of the present disclosure;

FIG. 9 schematically shows a mixed-phase wavelet extracted by an existing method;

FIGS. 10a-10b schematically show fine characterization results according to Embodiment 2 of the present disclosure, where (a): fine characterization results acquired by the method of the present disclosure; and (b) fine characterization results acquired by a conventional method;

FIGS. 11a-11b respectively are enlarged views of FIG. 10a and FIG. 10b;

FIG. 12 is a partially enlarged view of initial data in Embodiment 2 of the present disclosure; and

FIGS. 13a-13b schematically show fine characterization results according to Embodiment 2 of the present disclosure, where (a): fine characterization results acquired by the method of the present disclosure; and (b) fine characterization results acquired by a conventional method.

### DETAILED DESCRIPTION OF EMBODIMENTS

The technical solutions in the embodiments of the present disclosure will be described clearly and completely with reference to the accompanying drawings. Individual embodiments and the technical features recited therein can be combined in the case of no contradiction. Unless otherwise specified, all technical and scientific terms used in this application have the same meaning as commonly understood by one of ordinary skill in the art to which this application belongs. As used herein, term “including” or “comprising” is intended to mean that the preceding component or object covers the following components or objects without excluding other components or objects.

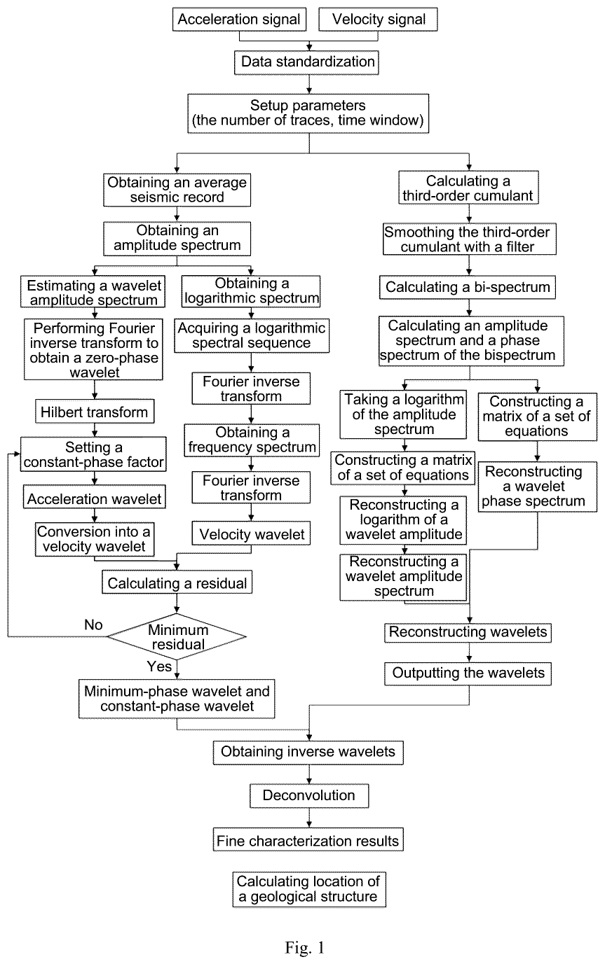

As shown in FIG. 1, this application provides a geological structure characterization method based on joint extraction of a seismic velocity signal and a seismic acceleration signal, which includes the following steps. The seismic acceleration signal and the seismic velocity signal are acquired respectively through an acceleration seismometer and a velocity seismometer, and normalized. Parameters are set based on wavelet phase requirements to carry out constant-phase wavelet and minimum-phase wavelet extraction or to extract a mixed-phase wavelet.

The acceleration signal has a huge advantage over the velocity signal in terms of bandwidth and octave range, while the velocity signal has richer effective information in the low-frequency part than the acceleration signal. The present disclosure combines the velocity signal and the acceleration signal for wavelet extraction, which preserves factors, such as bandwidth, and the low-frequency effective signals, thereby improving the accuracy of the wavelet extraction results.

It should be noted that the normalized processing of the signal is known in the prior art, and the specific steps will not be repeated herein. The setting of parameters, including the number of processing channels, time windows, etc., is also known in the prior art, thus the specific details are not repeated herein.

In an embodiment, the extraction of the constant-phase wavelet and the extraction of the minimum-phase wavelets are carried out through the following steps.

(S1) A first minimum-phase wavelet is extracted based on the seismic velocity signal to obtain through the following formulas:

$$a ( n ) = u ( n ) {a}_{o} ( n ) ; \qquad ( 1 )$$

$$u ( n ) = \{ \begin{matrix}0 & n < 0 \\ 1 & n = 0 \\ 2 & n > 0\end{matrix} ; \qquad ( 2 )$$

$${a}_{o} ( n ) = IFFT ( {A}_{o} ( ω ) ) ; and \qquad ( 3 )$$

$${A}_{o} ( ω ) = ln \vert X ( ω ) \vert ; \qquad ( 4 )$$

where a(n) represents the first minimum-phase wavelet; u(n) represents a coefficient; aₒ(n) is an odd part sequence of a(n); n represents a time sequence; IFFT represents Fourier inverse transform; Aₒ(ω) represents a Fourier transform result of aₒ(n); and |X(ω)| represents an amplitude spectrum of a seismic record.

In the above embodiment, the extraction formula for the first minimum-phase wavelet is derived by the following steps.

Assuming that the seismic wavelet is b(n), the logarithmic spectrum of the wavelet A(ω) can be written as:

$$A ( ω ) = ln B ( ω ) ; \qquad ( 17 )$$

where B(ω) represents a frequency spectrum of the seismic wavelet; and ln represents a logarithm function with a base of e.

Assuming that a(n) is the time sequence of the logarithmic spectrum of the seismic wavelet b(n) (i.e., the minimum phase wavelet). It is theoretically proven that if a wavelet is a minimum-phase wavelet, the time sequence of its logarithmic spectrum is a real-valued causal sequence. Any real-valued sequence can be written as the sum of its odd-part sequence and its even-part sequence, so a(n) can be written as:

$$a ( n ) = {a}_{o} ( n ) + {a}_{e} ( n ) ; \qquad ( 18 )$$

where aₑ(n) represents an even-part sequence of the time sequence a(n) of the log-spectrum.

Since a(n) has causality, a(n) can be written as the expression shown in formula (1), and u(n) in formula (1) is shown in formula (2). Hence, only the odd-part sequence aₒ(n) is obtained, and the minimum-phase wavelet can be obtained by formula (1).

Taking logarithms for the left and right sides of formula (31), the following formula is obtained:

$$ln \vert B ( ω ) \vert = ln \vert X ( ω ) \vert . \qquad ( 19 )$$

Meanwhile, the frequency spectrum of the wavelet can be expressed as:

$$B ( ω ) = \vert B ( ω ) \vert {e}^{i φ ( ω )} ; \qquad ( 20 )$$

where φ(ω) represents a phase of the wavelet.

Then, formula (19) is substituted into formula (17) to obtain:

$$A ( ω ) = ln B ( ω ) = ln \vert B ( ω ) \vert + i φ ( ω ) . \qquad ( 21 )$$

At the same time, there are:

$${A}_{o} ( ω ) = {A}_{R} ( ω ) ; \qquad ( 22 )$$

$${A}_{e} ( ω ) = {A}_{I} ( ω ) ; and \qquad ( 23 )$$

$$A ( ω ) = {A}_{o} ( ω ) + {iA}_{e} ( ω ) ; \qquad ( 24 )$$

where Aₒ(ω) and Aₑ(ω) are Fourier transform results of aₒ(n) and aₑ(n), respectively; A_{R}(ω) and A_{I}(ω) are the real and imaginary parts of the wavelet logarithmic spectrum, respectively; and i represents an imaginary unit.

Formulas (21)-(24) are subjected to simultaneity to obtain:

$${A}_{o} ( ω ) = ln \vert B ( ω ) \vert ; \qquad ( 25 )$$

That is, Aₒ(ω)=ln|B(ω)|=ln|X(ω)| (26);

Thus, the Aₒ(ω) shown in formula (4) can be computed, and from this, the aₒ(n) shown in formula (3) can also be computed. Finally, u(n) is determined from the value of n, and the odd-part sequence aₒ(n) can be calculated by formula (3) to extract the minimum-phase wavelet based on the velocity signal through formula (1).

(S2) The constant-phase wavelet is extracted based on the seismic acceleration signal to obtain the constant-phase wavelet, and the constant-phase wavelet is converted to obtain a second minimum-phase wavelet.

In an embodiment, the constant-phase wavelet is extracted based on the seismic acceleration signal through the following formulas:

$$g ( a , n ) = b ( n ) cos ( a ) - {h}_{b} ( n ) sin ( a ) ; and \qquad ( 5 )$$

$$b ( n ) = IFFT ( \vert X ( ω ) \vert ) ; \qquad ( 6 )$$

where g(a, n) represents the constant-phase wavelet; b(n) represents a zero-phase wavelet; a represents a phase correction factor; and h_{b}(n) is a Hilbert transform result of b(n).

Optionally, the phase correction factor is expressed as:

$$a = \frac{π}{k} , k = 1 , 2 , 3 … ;$$

where k is a positive integer.

In the above embodiment, the constant-phase wavelet extraction formula is derived by the following steps.

Assuming that the seismic record is x(n), the reflection coefficient is r(n), and the seismic wavelet is b(n) (the seismic wavelet is a zero-phase wavelet when the wavelet phase is zero). Then, the seismic convolution model can be expressed as:

$$x ( n ) = b ( n ) * r ( n ) . \qquad ( 27 )$$

Firstly, the Fourier transform is performed on both sides of formula (27) to obtain the expression of the convolution model in the frequency domain, as shown below:

$$X ( ω ) = B ( ω ) * R ( ω ) ; \qquad ( 28 )$$

where X(ω) is the Fourier transform of x(n), B(ω) is the Fourier transform of b(n), and R(ω) is the Fourier transform of r(n).

Assuming that the reflection coefficient is a white noise sequence, the amplitude spectrum is expressed as:

$$\vert R ( ω ) \vert = 1. \qquad ( 29 )$$

Then, the amplitude spectrum of the seismic record x(n) can be written as:

$$\vert X ( ω ) \vert = \vert B ( ω ) \vert \vert R ( ω ) \vert = \vert B ( ω ) \vert ; \qquad ( 30 )$$

that is, |B(ω)|=|X(ω)| (31).

Formula (31) shows that the amplitude spectrum |B(ω)| of the wavelet can be estimated from the amplitude spectrum |X(ω)| of the seismic record.

Meanwhile, the frequency spectrum of the wavelet can be expressed as:

$$B ( ω ) = \vert B ( ω ) \vert {e}^{i φ ( ω )} ; \qquad ( 32 )$$

where φ(ω) represents the phase of the wavelet.

Secondly, when the phase of the wavelet is zero, i.e., φ(ω)=0 in formula (32), the following formula can be obtained:

$$b ( n ) = IFFT ( B ( ω ) ) = IFFT ( \vert B ( ω ) \vert ) = IFFT ( \vert X ( ω ) \vert ) . \qquad ( 33 )$$

From this, the zero-phase wavelet calculation formula shown in formula (6) can be obtained, and the zero-phase wavelet b(n) can be obtained by performing Fourier inverse transform on the amplitude spectrum |X(ω)| of the seismic record.

Again, the phase correction can be performed on the zero-phase wavelet to obtain the expression of the constant-phase wavelet in the frequency domain:

$$G ( a , ω ) = \{ \begin{matrix}B ( ω ) {e}^{ia} = B ( ω ) ( cos ( a ) + i sin ( a ) ) & ω > 0 \\ B ( ω ) {e}^{- ia} = B ( ω ) ( cos ( a ) - i sin ( a ) ) & ω < 0\end{matrix} ; \qquad ( 34 )$$

where G(α, ω) is the frequency spectrum of the constant-phase wavelet.

Next, assuming that the frequency response of the Hilbert transform factor is H(ω), then:

$$H ( ω ) = \{ \begin{matrix}- i & ω > 0 \\ i & ω < 0\end{matrix} . \qquad ( 35 )$$

Formula (35) is substituted into formula (34) to obtain:

$$G ( a , ω ) = B ( ω ) cos ( a ) - H ( ω ) sin ( a ) . \qquad ( 36 )$$

From this, the constant-phase wavelet extraction formula shown in formula (5) can be obtained, and the constant-phase wavelet of the acceleration signal can be extracted by using this formula.

(S3) A residual between the first minimum-phase wavelet and the second minimum-phase wavelet is calculated. If the residual is greater than a preset threshold, returning to step (S2) and the constant-phase wavelet extraction is performed again. If the residual is less than or equal to the preset threshold, the first minimum-phase wavelet and the constant-phase wavelet are output.

It should be noted that when the residual is greater than a preset threshold to return to step (S2), a new constant-phase factor is extracted by resetting a new phase correction factor. The new phase correction factor can be obtained by formula (7), and the value of k is taken one place backward for each update of the phase correction factor.

It should be noted that the residual threshold is an artificially set threshold, and the smaller the residual threshold is, the higher the accuracy of the obtained results. The present disclosure utilizes that the seismic acceleration signal is equal to the derivative of the seismic velocity signal, with the first minimum-phase wavelet obtained by the extraction of the velocity signal as a benchmark, to convert the constant-phase wavelet obtained by the extraction of the acceleration signal into a second minimum-phase wavelet. By comparing the first minimum-phase wavelet with the second minimum-phase wavelet, the constant-phase factor can be determined. This can avoid the uncertainty brought about by the artificially-set constant phase factor, and ultimately improves the extraction accuracy of the constant phase wavelet.

In an embodiment, the mixed-phase wavelet is extracted through the following formula:

$$\begin{matrix}w = IFFT ( W ) ; and & ( 8 ) \\ W = sin ( {Φ}^{′} ) \vert W \vert + j cos ( {Φ}^{′} ) \vert W \vert ; & ( 9 )\end{matrix}$$

where w represents the mixed-phase wavelet; W represents a wavelet frequency spectrum; Φ′ represents a wavelet phase spectrum; |W| represents a wavelet amplitude spectrum; and j is an imaginary number.

Optionally, the phase spectrum Φ′ of the mixed-phase wavelet is calculated through the following formulas:

$$\begin{matrix}{Φ}^{′} = {( {A}_{pha}^{T} {A}_{pha} )}^{- 1} {A}_{pha}^{T} {φ}^{′} ; & ( 10 ) \\ {A}_{pha} = [ \begin{matrix}2 & - 1 & 0 & 0 & ⋯ & 0 & 0 \\ 1 & 1 & - 1 & 0 & ⋯ & 0 & 0 \\ ⋮ & ⋮ & ⋮ & ⋮ & ⋱ & ⋮ & ⋮ \\ 1 & 0 & 0 & 0 & … & 1 & - 1 \\ 0 & 2 & 0 & - 1 & ⋯ & 0 & 0 \\ ⋮ & ⋮ & ⋮ & ⋮ & ⋱ & ⋮ & ⋮ \\ 0 & 0 & 0 & 0 & ⋱ & 0 & 1\end{matrix} ] ; and & ( 11 ) \\ {φ}^{′} = {( {φ}^{′} ( 1 , 1 ) , {φ}^{′} ( 1 , 2 ) , … , {φ}^{′} ( 1 , N - 1 ) , {φ}^{′} ( 2 , 2 ) , … , {φ}^{′} ( 2 , N - 2 ) , … , {φ}^{′} ( \frac{N}{2} , \frac{N}{2} ) )}^{T} ; & ( 12 )\end{matrix}$$

where Aₚₕₐ is a (N²/4)×N matrix; T represents a matrix transpose operation; −1 denotes a matrix inversion operation; φ′ is a (N²/4)×1 column vector; and N represents a size of a higher-order cumulant matrix.

Optionally, the amplitude spectrum |W| of the mixed-phase wavelet is calculated through the following formulas:

$$\begin{matrix}\vert W ( n ) \vert = \{ \begin{matrix}{e}^{{W}^{′} ( n )} , n = 1 , 2 , 3 ⋯ , N / 2 \\ \vert W ( N - n ) \vert , n = \frac{N}{2} + 1 , \frac{N}{2} + 2 , ⋯ , N - 1\end{matrix} ; & ( 13 ) \\ {W}^{′} = {( {A}_{amp}^{T} {A}_{amp} )}^{- 1} {A}_{amp}^{T} {X}^{′} ; & ( 14 ) \\ {A}_{amp} = [ \begin{matrix}2 & 1 & 0 & 0 & ⋯ & 0 & 0 \\ 1 & 1 & 1 & 0 & ⋯ & 0 & 0 \\ ⋮ & ⋮ & ⋮ & ⋮ & ⋱ & ⋮ & ⋮ \\ 1 & 0 & 0 & 0 & … & 1 & 0 \\ 0 & 2 & 0 & 1 & ⋯ & 0 & 0 \\ ⋮ & ⋮ & ⋮ & ⋮ & ⋱ & ⋮ & ⋮ \\ 0 & 0 & 0 & 0 & ⋱ & 0 & 1\end{matrix} ] ; and & ( 15 ) \\ {X}^{′} = {( {X}^{′} ( 1 , 1 ) , {X}^{′} ( 1 , 2 ) , … , {X}^{′} ( 1 - \frac{N}{2} - 1 ) , {X}^{′} ( 2 , 2 ) , … , {X}^{′} ( 2 , \frac{N}{2} - 2 ) , … , {X}^{′} ( \frac{N}{4} , \frac{N}{4} ) )}^{T} ; & ( 16 )\end{matrix}$$

where |W(n)| represents a wavelet amplitude spectrum; e represents a base of a natural logarithm function; W′(n) represents a natural logarithm of the wavelet amplitude spectrum; n represents a time sequence; N represents a size of a higher-order cumulant matrix; |W(N−n)| represents a part of the wavelet amplitude spectrum greater than one half of a wavelet length; W′ represents a (N/2)×1 column vector; Aₐₘₚ represents a (N²/16)×(N/2) matrix; T represents a matrix transpose operation; −1 represents a matrix inversion operation; and X′ represents a (N²/16)×1 column vector.

In the above embodiment, the mixed phase wavelet is extracted by utilizing the higher-order accumulation of the acceleration signal and the velocity signal, which can satisfy the characteristics of the attenuated wavelet to render the extraction results more in line with reality.

In the above embodiment, the mixed-phase wavelet extraction formula is derived by the following steps.

Assuming that there exists a zero-mean smooth stochastic process y(n), where n=0, ±1, ±2, . . . .

Then the third-order cumulative quantity of y(n) can be expressed as:

$${cum}_{3 y} ( {τ}_{1} , {τ}_{2} ) = E [ y ( n ) y ( n + {τ}_{1} ) y ( n + {τ}_{2} ) ] ; \qquad ( 37 )$$

where E[·] denotes the calculated mathematical expectation.

The above equation can be rewritten as:

$${cum}_{3 y} ( {τ}_{1} , {τ}_{2} ) = {\sum }_{n = - ∞}^{∞} y ( n ) y ( n + {τ}_{1} ) y ( n + {τ}_{2} ) . \qquad ( 38 )$$

The k−1^{th} Fourier transform of the k^{th} order cumulative quantity is its k^{th} order spectrum, also called k−1 spectrum. Then, the third-order spectrum (bispectrum) of the above third-order cumulative quantity can be expressed as:

$${C}_{3 y} ( {ω}_{1} , {ω}_{2} ) = {\sum }_{{τ}_{1} = - ∞}^{∞} {\sum }_{{τ}_{2} = - ∞}^{∞} {cum}_{3 y} ( {τ}_{1} , {τ}_{2} ) {e}^{- j ( {ω}_{1} {τ}_{1} + {ω}_{2} {τ}_{2} )} . \qquad ( 39 )$$

The formula (38) is substituted into formula (39) to obtain:

$${C}_{3 y} ( {ω}_{1} , {ω}_{2} ) = {\sum }_{n = - ∞}^{∞} {\sum }_{{τ}_{1} = - ∞}^{∞} {\sum }_{{τ}_{2} = - ∞}^{∞} y ( n ) y ( n + {τ}_{1} ) y ( n + {τ}_{2} ) {e}^{- j ( {ω}_{1} {τ}_{1} + {ω}_{2} {τ}_{2} )} ; \qquad ( 40 )$$

i.e.:

$${C}_{3 y} ( {ω}_{1} , {ω}_{2} ) = {\sum }_{n = - ∞}^{∞} y ( n ) {e}^{j n ( {ω}_{1} + {ω}_{2} )} {\sum }_{{τ}_{1} = - ∞}^{∞} y ( n + {τ}_{1} ) {e}^{- j {ω}_{1} ( n + {τ}_{1} )} {\sum }_{{τ}_{2} = - ∞}^{∞} y ( n + {τ}_{2} ) {e}^{- j {ω}_{2} ( n + {τ}_{2} )} = Y ( {ω}_{1} + {ω}_{2} ) Y ( {ω}_{1} ) Y ( {ω}_{2} ) = \vert {cum}_{3 y} ( {ω}_{1} , {ω}_{2} ) \vert {e}^{j {φ}_{3 x} ( {ω}_{1} , {ω}_{2} )} ; \qquad ( 41 )$$

where Y is the Fourier transform of y(n).

Then, the amplitude spectrum and phase spectrum of the third-order spectrum can be respectively expressed as:

$$\vert cu {m}_{3 y} ( {ω}_{1} , {ω}_{2} ) \vert = \vert Y ( {ω}_{1} ) \vert \vert Y ( {ω}_{2} ) \vert \vert Y ( {ω}_{1} + {ω}_{2} ) \vert ; and \qquad ( 42 )$$

$${φ}_{3 y} ( {ω}_{1} , {ω}_{2} ) = {Φ}_{y} ( {ω}_{1} ) + {Φ}_{y} ( {ω}_{2} ) - {Φ}_{y} ( {ω}_{1} + {ω}_{2} ) . \qquad ( 43 )$$

Assuming that the seismic record is x(t), the convolution model can be expressed as:

$$x ( t ) = w ( t ) * r ( t ) + v ( t ) ; \qquad ( 44 )$$

where w(t) represents the seismic wavelet sequence; r(t) represents the reflection coefficient sequence; v(t) represents the Gaussian noise sequence; and * represents convolution.

Formula (44) is subjected to Fourier transform to obtain:

$$X ( ω ) = W ( ω ) * R ( ω ) + V ( ω ) ; \qquad ( 45 )$$

where X(ω), W(ω), R(ω), and V(ω) are the Fourier transforms of x(t), w(t), r(t), and v(t), respectively.

Then, the bi-spectrum of x(t) is:

$${C}_{3 x} ( {ω}_{1} , {ω}_{2} ) = {C}_{3 w} ( {ω}_{1} , {ω}_{2} ) {C}_{3 r} ( {ω}_{1} , {ω}_{2} ) + {C}_{3 v} ( {ω}_{1} , {ω}_{2} ) . \qquad ( 46 )$$

Since the higher-order cumulative quantity of the Gaussian random variable is zero, then:

$${C}_{3 v} ( {ω}_{1} , {ω}_{2} ) = 0. \qquad ( 47 )$$

Hence, formula (47) is substituted into formula (46) to obtain:

$${C}_{3 x} ( {ω}_{1} , {ω}_{2} ) = {C}_{3 w} ( {ω}_{1} , {ω}_{2} ) {C}_{3 r} ( {ω}_{1} , {ω}_{2} ) . \qquad ( 48 )$$

Typically, the higher-order accumulation of the reflection coefficient is assumed to be a multidimensional impulse function, then formula (48) can be written as:

$${C}_{3 x} ( {ω}_{1} , {ω}_{2} ) = {C}_{3 w} ( {ω}_{1} , {ω}_{2} ) / {σ}^{2} ; \qquad ( 49 )$$

where σ represents the variance of the reflection coefficient sequence.

Formula (49) shows that there is only one scale factor difference between the third-order spectrum of the wavelet and the third-order spectrum of the seismic record. Therefore, the third-order spectrum of the seismic record can be used to determine the spectrum of the wavelet.

Taking the logarithm of both sides of formula (42) to obtain:

$$ln \vert {cum}_{3 y} ( {ω}_{1} , {ω}_{2} ) \vert = ln \vert Y ( {ω}_{1} ) \vert + ln \vert Y ( {ω}_{2} ) \vert + ln \vert Y ( {ω}_{1} + {ω}_{2} ) \vert . \qquad ( 50 )$$

Formula (50) is applied to the seismic data to obtain:

$$ln \vert {cum}_{3 x} ( {ω}_{1} , {ω}_{2} ) \vert = ln \vert W ( {ω}_{1} ) \vert + ln \vert W ( {ω}_{2} ) \vert + ln \vert W ( {ω}_{1} + {ω}_{2} ) \vert . \qquad ( 51 )$$

Allowing ln|cum₃ₓ(ω₁, ω₂)|=X′ (k, l) and ln|W|=W′, and formula (51) can be written as:

$${X}^{′} ( k , l ) = {W}^{′} ( k ) + {W}^{′} ( l ) + {W}^{′} ( k + l ) . \qquad ( 52 )$$

Formula (52) shows that X′ is a linear combination of W′, so formula (52) can be written in matrix form as follows:

$${X}^{′} = {A}_{a m p} {W}^{′} ; \qquad ( 53 )$$

where the specific forms of X′ and Aₐₘₚ are shown in formulas (16) and (15), respectively.

Aₐₘₚ is a column non-singular matrix. Therefore, the generalized inverse matrix can be used to solve formula (53) to solve the expression of W′ shown in formula (14), and the wavelet amplitude spectrum can be solved using formula (13).

Formula (13) is applied to the seismic data to obtain:

$${φ}_{3 x} ( {ω}_{1} , {ω}_{2} ) = {Φ}_{w} ( {ω}_{1} ) + {Φ}_{w} ( {ω}_{2} ) - {Φ}_{w} ( {ω}_{1} + {ω}_{2} ) . \qquad ( 54 )$$

Formula (54) indicates that φ₃ₓ is a linear combination of Φ_{w}, and thus formula (54) can be written in a matrix form as follows:

$${φ}^{′} = {A}_{p h a} {Φ}^{′} ; \qquad ( 55 )$$

where Φ′ represents N×1 column vector.

The specific expressions of φ′ and Aₚₕₐ in the formula (55) are shown in formula (12) and formula (11), respectively.

Aₚₕₐ is a column non-singular matrix. Therefore, the generalized inverse matrix can be used to solve formula (55) to solve the expression for the wavelet phase spectrum shown in formula (10), which can be used to solve the wavelet phase spectrum.

The method using the above-mentioned phase recovery utilizes all possible bi-spectral phase values that can be obtained, and is a non-recursive algorithm. Thus, there is no cumulative error in the calculation process.

Based on the calculation results of formulas (10) and (13), the spectrum of the wavelet can be obtained computationally using formula (9). Then the Fourier inverse transform is performed on formula (9) to obtain the mixed-phase wavelet extraction formula shown in formula (8), and the mixed-phase wavelet of the seismic record can be solved by formula (8).

In an embodiment, a method for extracting wavelets using the above-mentioned method for combined wavelet extraction of seismic velocity signals and seismic acceleration signals is provided, which includes the following steps.

(1) A seismic acceleration signal and a seismic velocity signal are acquired and normalized.

(2) Parameters (number of processing channels, time window, etc.) are set, and the data within the time window are averaged to obtain an averaged seismic record and its amplitude spectrum.

(3) A Fourier inverse transform is performed on the amplitude spectrum obtained from the acceleration signal to obtain a zero-phase wavelet.

(4) A Hilbert transform is performed on the zero-phase wavelet, and a constant-phase factor is set to extract an acceleration wavelet (i.e., the constant-phase wavelet).

(5) A logarithmic operation is performed on the amplitude spectrum obtained from the velocity signal to obtain a logarithmic spectrum sequence.

(6) A Fourier inverse transform is performed on the logarithmic spectrum to obtain a frequency spectrum, and then a velocity wavelet (i.e., the first minimum phase wavelet) is extracted.

(7) The acceleration wavelet is converted into a velocity wavelet (i.e., the second minimum phase wavelet), and the residual between the converted velocity wavelet and the original velocity wavelet is calculated. If the residual satisfies the accuracy requirement, the calculation is stopped, and the jointly extracted velocity wavelet and acceleration wavelet are output. If the accuracy requirement is not satisfied, the phase correction factor is re-selected, and the above operations are repeated until the accuracy requirement is satisfied;

(8) After extracting the constant-phase wavelet and the minimum-phase wavelets, the data after preprocessing (normalization, parameterization, and averaging) are converted to the acceleration domain and spliced with the acceleration signal after preprocessing to obtain fused data.

(9) A third-order cumulative quantity of the fused data and the third-order spectrum (bi-spectrum) of the fused data are calculated. The third-order cumulative quantity is filtered using a Parzen window, and thereafter an amplitude spectrum and a phase spectrum of the wavelet are calculated using the bi-spectrum. Ultimately, the mixed-phase wavelet is reconstructed.

### Embodiment 1

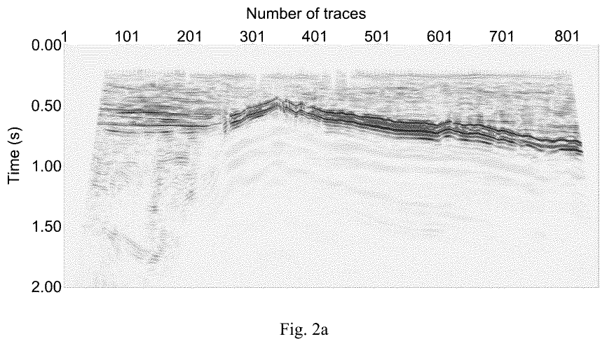

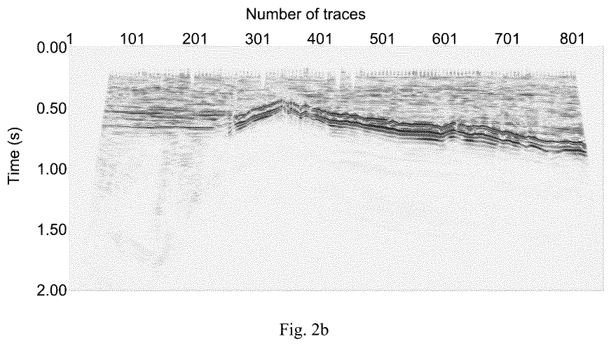

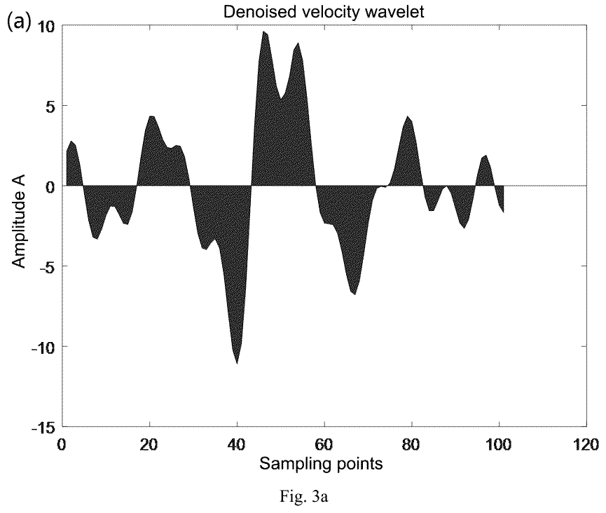

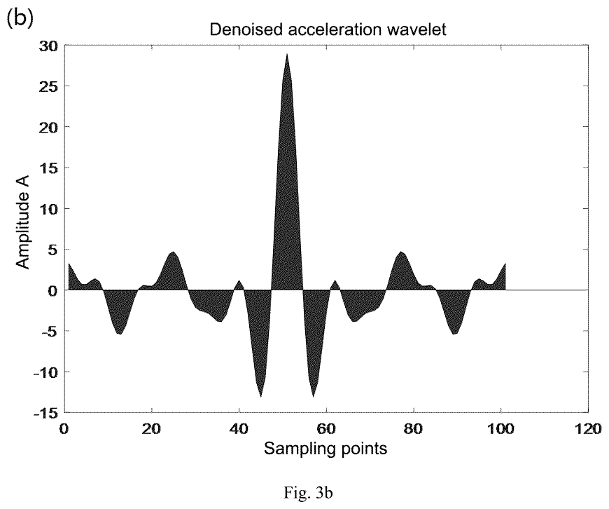

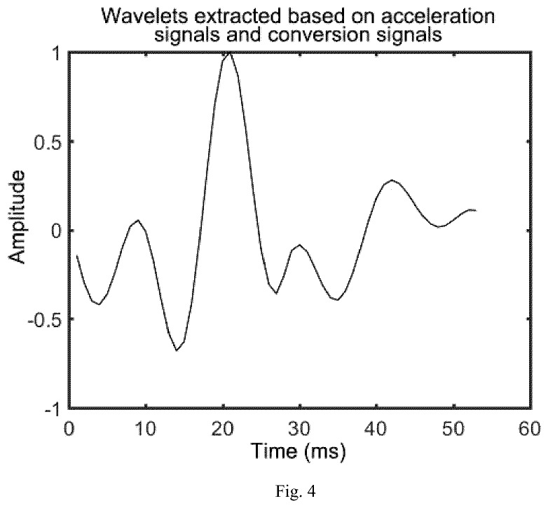

In Embodiment 1, the seismic signal of a work area is selected, as shown in FIG. 2, with the time range of 0-2 s, the number of channels of 1-853, and the residual threshold of 0.001. The final outputs of the jointly extracted velocity wavelet and acceleration wavelet are shown in FIGS. 3a-3b, respectively. The mixed-phase wavelet reconstructed by using the bi-spectrum of the higher-order cumulative quantity is shown in FIG. 4.

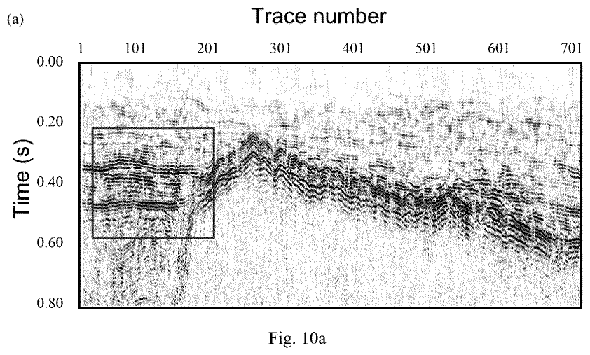

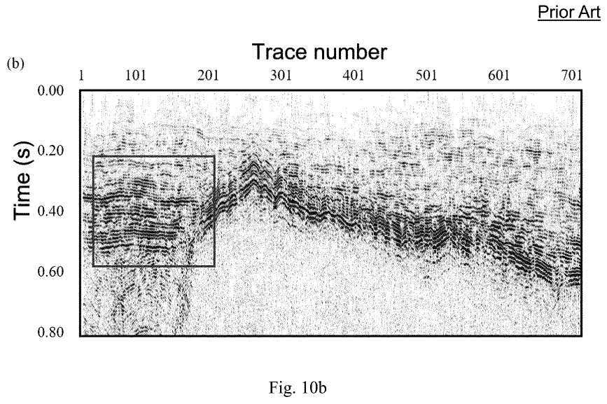

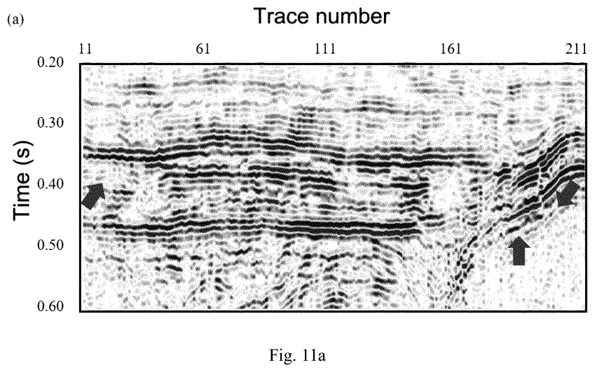

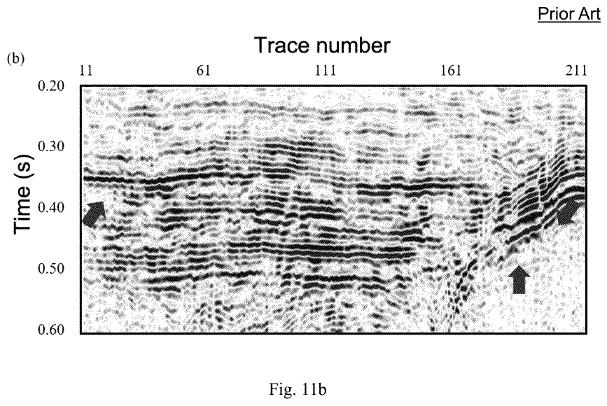

The mixed-phase wavelet (shown in FIG. 4) extracted by the method provided in the present disclosure, the wavelet obtained by the conventional method and the original seismic acceleration signal (shown in FIG. 2b) are subjected to the deconvolution to obtain the fine characterization results as shown in FIGS. 10a-10b, where (a): fine characterization results obtained by the method proposed in the present disclosure; and (b): fine characterization results obtained by using the conventional method. FIGS. 11a-11b respectively are enlarged results of FIG. 10a and FIG. 10b. Comparing the fine characterization results obtained by different methods in FIGS. 11a-11b, the fine characterization results obtained by the present disclosure have a clearer image at the position pointed out by the arrow, and have a better continuity, i.e., the method in the present disclosure can recognize the continuous structure at the 200^{th} channel at 0.45 s, but the conventional method can only recognize the 200^{th} channel at 0.43 s. The channel spacing is 10 m, and the speed is 1000 m/s, that is, the method of the present disclosure identifies the structure with a lateral position of 2000 m and a longitudinal position of 450 m, while the conventional method identifies the structure with a lateral position of 2000 m and a longitudinal position of 430 m. Combined with the actual seismic situation that the structure at a lateral position of 2000 m has a longitudinal depth of 500 m, it indicates the location obtained by the characterization method of the present disclosure is closer to the actual situation than that identified by the conventional method.

### Embodiment 2

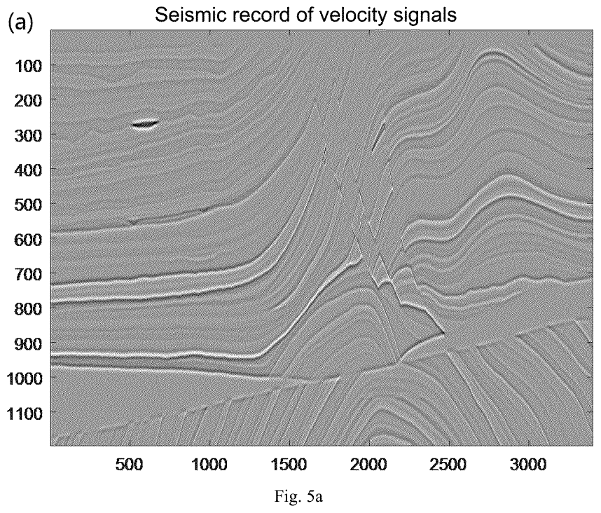

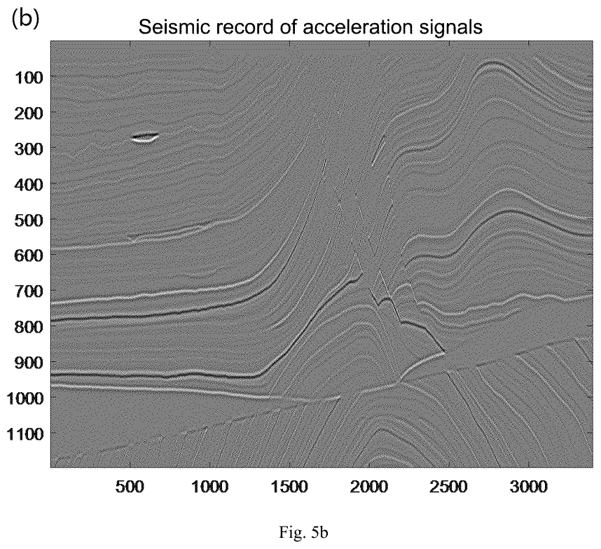

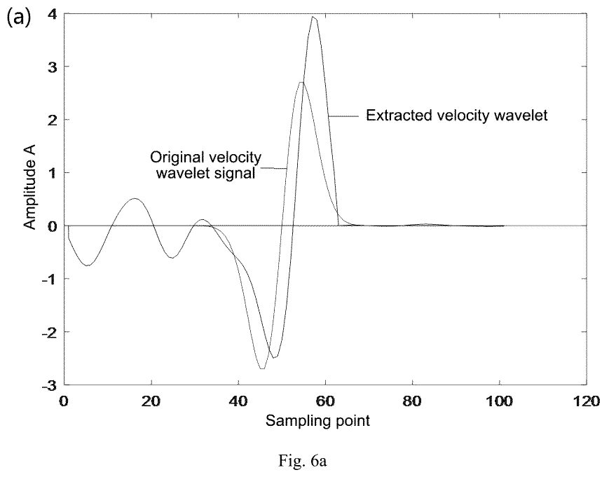

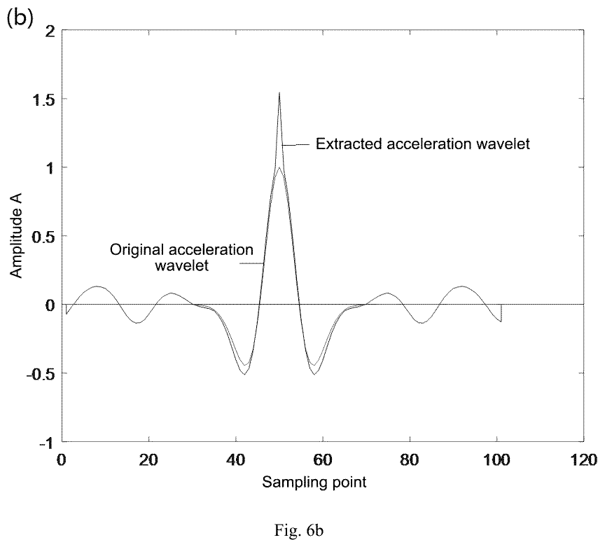

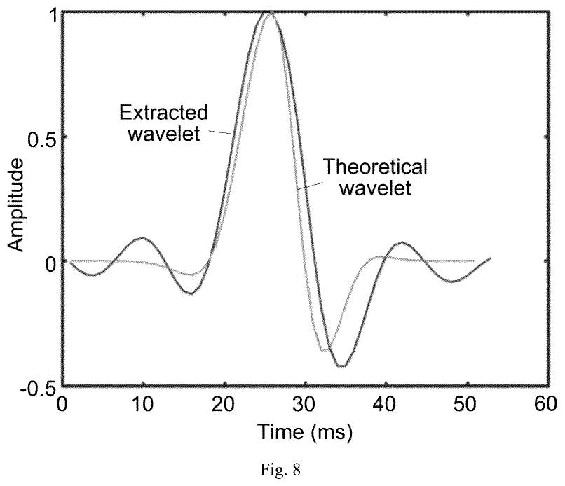

In Embodiment 2, seismic signals from a work zone as shown in FIGS. 5a-5b for the marmousi2 model are selected, with a time of 0-1.2 s, a channel number of 1-3500, and a residual threshold of 0.001. The extracted velocity wavelet and acceleration wavelet are shown in FIGS. 6a-6b, and the mixed-phase wavelet reconstructed using the bi-spectral reconstruction of the higher-order cumulants is shown in FIG. 8.

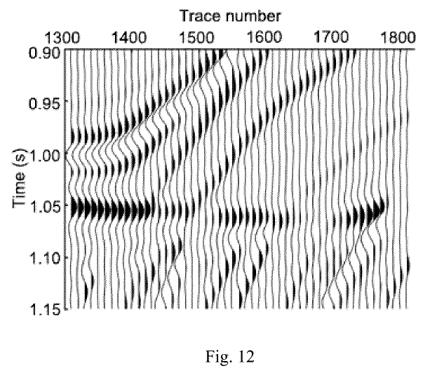

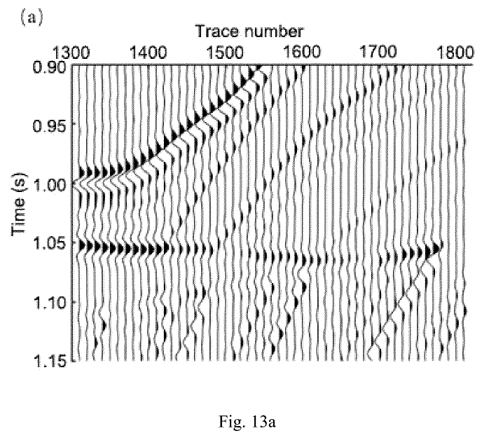

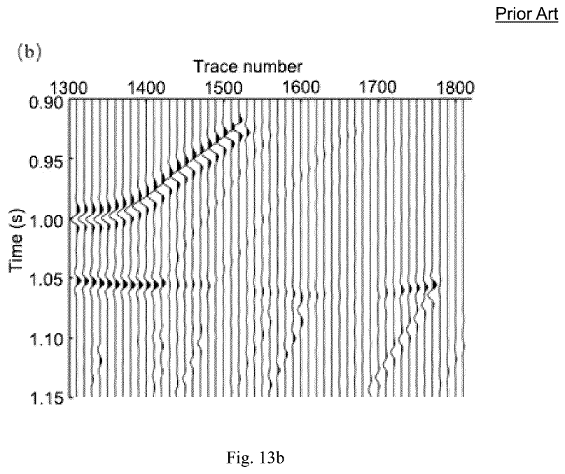

The mixed-phase wavelet extracted by the method proposed in Embodiment 2 of the present disclosure (shown in FIG. 8), the wavelet obtained by the conventional method and the original seismic acceleration signal as shown in FIG. 5b are subjected to deconvolution to obtain fine characterization results. To show the relevant details, the fine characterization results are enlarged, as shown in FIGS. 13a-13b, where a (a): fine characterization results acquired by the depiction method of the present disclosure; and (b) fine characterization results acquired by the conventional method. The results shown in FIG. 12 are amplified display results of the original signal. By comparing fine characterization results obtained by different methods in FIGS. 13a-13b, with a channel spacing of 10 m (i.e., the distance between each two channels is 10 m) and a speed of 500 m/s, the pinch-out point location identified by the method proposed by the present disclosure is at 1600^{th} channel at 1.80 s, which corresponds to the actual situation of the position with a lateral position of 1600 m and a longitudinal depth of the 900 m. However, the conventional method can only identify the pinch-out point location at 1560^{th} channel at 1.84 s, which corresponds to the actual situation of the position with a lateral position of 1560 m and a longitudinal depth of 920 m. Considering that the position of the actual pinch-out point is at a lateral position of 1650 m and a longitudinal depth of 860 m. Therefore, the fine characterization results obtained by the method proposed in the present disclosure are closer to the actual location of the pinch-out point than the results obtained by the conventional method.

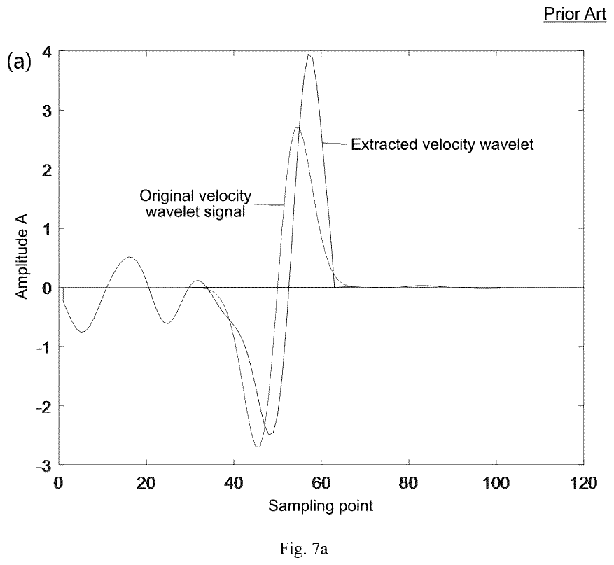

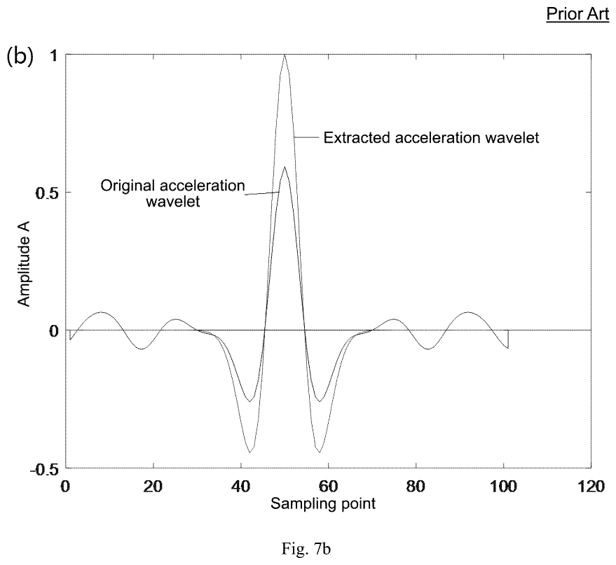

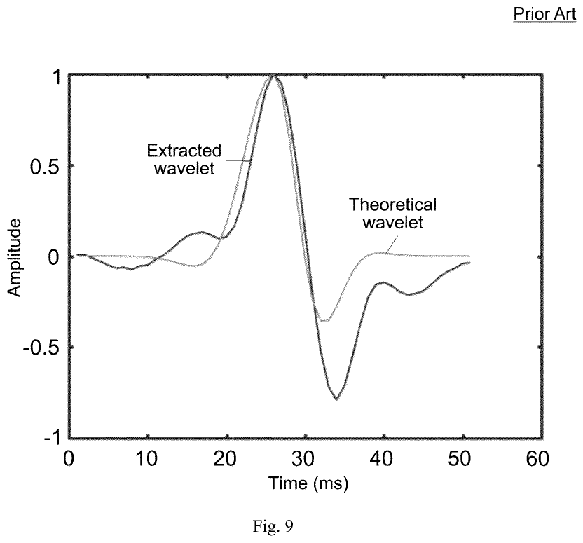

In the wavelet extraction on the above Marmousi2 model, instead of using the combined wavelet extraction method of the present disclosure, the velocity wavelet and the acceleration wavelet are extracted separately by using the existing method with all other parameters (e.g., number of processing channels, time window range) being the same, and the results are shown in FIGS. 7a-7b. The mixed-phase wavelet results extracted by using the existing method (without filter smoothing of third-order cumulative quantities) are shown in FIG. 9.

By comparing FIGS. 6a-6b and FIGS. 7a-7b, it can be seen that the velocity wavelet extracted separately by the existing method is basically the same as the velocity wavelet obtained by the joint extraction of the present disclosure, but the acceleration wavelet extracted separately is weaker than the acceleration wavelet obtained by the joint extraction of the present disclosure in terms of amplitude strength and other aspects.

By comparing FIGS. 8 and 9, it can be seen that the mixed-phase wavelet obtained by the joint extraction method of the present disclosure is closer to the theoretical wavelet than the mixed-phase wavelet separate extracted by the existing method, and has a higher accuracy.

In summary, the present disclosure enables the extraction of theoretical wavelets such as constant-phase wavelet and minimum phase wavelet, and can also extract the mixed-phase wavelet that has the characteristics of attenuated wavelets. The two extraction methods both involve the combination of the seismic velocity signal and the acceleration signal, allowing for improved extraction accuracy. Compared with the prior art, the present disclosure has achieved significant improvement.

The above are only preferred embodiments of the present disclosure, and are not intended to limit the present disclosure in any forms. Though the present disclosure has been illustrated in detail above, one of ordinary skill in the art can still make various changes or modifications to the technical features recited in the embodiments. It should be understood that those modifications or changes made without departing from the spirit of the present disclosure shall still fall within the scope of the present disclosure defined by the appended claims.

What is claimed is:

1. A geological structure characterization method based on a seismic velocity signal and a seismic acceleration signal, comprising:
acquiring the seismic acceleration signal and the seismic velocity signal;
normalizing the seismic acceleration signal and the seismic velocity signal;
based on wavelet phase requirements, setting parameters to carry out constant-phase wavelet and minimum-phase wavelet extraction or to extract a mixed-phase wavelet; and
wherein the constant-phase wavelet and minimum-phase wavelet extraction is performed through the following steps:
(S1) extracting a first minimum-phase wavelet based on a normalized seismic velocity signal;
(S2) extracting a constant-phase wavelet based on a normalized seismic acceleration signal; and converting the constant-phase wavelet to obtain a second minimum-phase wavelet; and
(S3) calculating a residual between the first minimum-phase wavelet and the second minimum-phase wavelet;
if the residual is greater than a preset threshold, returning to step (S2) and performing constant-phase wavelet extraction again; and
if the residual is less than or equal to the preset threshold, outputting the first minimum-phase wavelet and the constant-phase wavelet;
wherein the geological structure characterization method further comprises:
after the constant-phase wavelet and minimum-phase wavelet extraction, converting the normalized seismic velocity signal in an acceleration domain followed by splicing with the normalized seismic acceleration signal to obtain fused data; and
calculating a third-order cumulant of the fused data and a third-order spectrum of the fused data; filtering the third-order cumulant using Parzen window; and calculating an amplitude spectrum and a phase spectrum of the constant-phase wavelet and the first minimum-phase wavelet using bispectrum analysis to reconstruct the mixed-phase wavelet;
the mixed-phase wavelet is extracted through the following formulas:
$$w = IFFT ( W ) ; and$$
$$W = sin ( {Φ}^{′} ) \vert W \vert + j cos ( {Φ}^{′} ) \vert W \vert ;$$
wherein w represents the mixed-phase wavelet; IFFT represents Fourier inverse transform; W represents a wavelet frequency spectrum; Φ′ represents a wavelet phase spectrum; |W| represents a wavelet amplitude spectrum; and j is an imaginary number.

2. The geological structure characterization method of claim 1, wherein in step (S1), the first minimum-phase wavelet is extracted based on the normalized seismic velocity signal through the following formulas:
$$a ( n ) = u ( n ) {a}_{o} ( n ) ;$$
$$u ( n ) = \{ \begin{matrix}0 & n < 0 \\ 1 & n = 0 \\ 2 & n > 0\end{matrix} ;$$
$${a}_{o} ( n ) = IFFT ( {A}_{o} ( ω ) ) ; and$$
$${A}_{o} ( ω ) = ln \vert X ( ω ) \vert ;$$
wherein a(n) represents the first minimum-phase wavelet; u(n) represents a coefficient; aₒ(n) is an odd-part sequence of a(n); n represents a time sequence; IFFT represents Fourier inverse transform; Aₒ(ω) represents a Fourier transform result of aₒ(n); and |X(ω)| represents an amplitude spectrum of a seismic record.

3. The geological structure characterization method of claim 1, wherein in step (S2), the constant-phase wavelet is extracted based on the normalized seismic acceleration signal through the following formulas:
$$g ( a , n ) = b ( n ) cos ( a ) - {h}_{b} ( n ) sin ( a ) ; and$$
$$b ( n ) = IFFT ( \vert X ( ω ) \vert ) ;$$
wherein g(a, n) represents the constant-phase wavelet; b(n) represents a zero-phase wavelet; a represents a phase correction factor; h_{b}(n) is a Hilbert transform result of b(n); IFFT represents Fourier inverse transform; and |X(ω)| represents an amplitude spectrum of a seismic record.

4. The geological structure characterization method of claim 3, wherein the phase correction factor is expressed as:
$$a = \frac{π}{k} , k = 1 , 2 , 3 … ;$$
wherein k is a positive integer.

5. The geological structure characterization method of claim 1, wherein the wavelet phase spectrum Φ′ is calculated through the following formulas:
$${Φ}^{′} = {( {A}_{pha}^{T} {A}_{pha} )}^{- 1} {A}_{pha}^{T} {φ}^{′} ;$$
$${A}_{pha} = [ \begin{matrix}2 & - 1 & 0 & 0 & … & 0 & 0 \\ 1 & 1 & - 1 & 0 & … & 0 & 0 \\ ⋮ & ⋮ & ⋮ & ⋮ & ⋱ & ⋮ & ⋮ \\ 1 & 0 & 0 & 0 & … & 1 & - 1 \\ 0 & 2 & 0 & - 1 & … & 0 & 0 \\ ⋮ & ⋮ & ⋮ & ⋮ & ⋱ & ⋮ & ⋮ \\ 0 & 0 & 0 & 0 & ⋱ & 0 & 1\end{matrix} ] ; and$$
$${φ}^{′} = {( {φ}^{′} ( 1 , 1 ) , {φ}^{′} ( 1 , 2 ) , … , \\ {φ}^{′} ( 1 , N - 1 ) , {φ}^{′} ( 2 , 2 ) , … , {φ}^{′} ( 2 , N - 2 ) , … , {φ}^{′} ( \frac{N}{2} , \frac{N}{2} ) )}^{T} ;$$
wherein Aₚₕₐ is a (N²/4)×N matrix; T represents a matrix transpose operation; −1 denotes a matrix inversion operation; φ′ is a (N²/4)×1 column vector; and N represents a size of a higher-order cumulant matrix.

6. The geological structure characterization method of claim 1, wherein the wavelet amplitude spectrum |W| is calculated through the following formulas:
$$\vert W ( n ) \vert = \{ \begin{matrix}{e}^{{W}^{′} ( n )} , n = 1 , 2 , 3 , … , N / 2 \\ \vert W ( N - n ) \vert , n = \frac{N}{2} + 1 , \frac{N}{2} + 2 , … , N - 1\end{matrix} ;$$
$${W}^{′} = {( {A}_{a m p}^{T} {A}_{a m p} )}^{- 1} {A}_{a m p}^{T} {X}^{′} ;$$
$${A}_{amp} = [ \begin{matrix}2 & 1 & 0 & 0 & … & 0 & 0 \\ 1 & 1 & 1 & 0 & … & 0 & 0 \\ ⋮ & ⋮ & ⋮ & ⋮ & ⋱ & ⋮ & ⋮ \\ 1 & 0 & 0 & 0 & … & 1 & 0 \\ 0 & 2 & 0 & 1 & … & 0 & 0 \\ ⋮ & ⋮ & ⋮ & ⋮ & ⋱ & ⋮ & ⋮ \\ 0 & 0 & 0 & 0 & ⋱ & 0 & 1\end{matrix} ] ; and$$
$${X}^{′} = {( {X}^{′} ( 1 , 1 ) , {X}^{′} ( 1 , 2 ) , … , {X}^{′} ( 1 , \frac{N}{2} - 1 ) , \\ {X}^{′} ( 2 , 2 ) , … , {X}^{′} ( 2 , \frac{N}{2} - 2 ) , … , {X}^{′} ( \frac{N}{4} , \frac{N}{4} ) )}^{T} ;$$
wherein |W(n)| represents the wavelet amplitude spectrum; e represents a base of a natural logarithm function; W′(n) represents a natural logarithm of the wavelet amplitude spectrum; n represents a time sequence; N represents a size of a higher-order cumulant matrix; |W(N−n)| represents a part of the wavelet amplitude spectrum greater than one half of a wavelet length; W′ represents a (N/2)×1 column vector; Aₐₘₚ represents a (N²/16)×(N/2) matrix; T represents a matrix transpose operation; −1 represents a matrix inversion operation; and X′ represents a (N²/16)×1 column vector.
